(19) United States
(12) Patent Application Publication
(10) Pub. No.: US 2012/0084140 A1
(43) Pub. Date: Apr. 5, 2012

(54) SYSTEM AND METHOD FOR ADJUSTING NUMBER OF ADVERTISEMENT INVENTORIES

(75) Inventors: Ki Oh KWON, Seongnam-si (KR); Seo Jin HAN, Seongnam-si (KR)

(73) Assignee: NHN BUSINESS PLATFORM CORP., Seongnam-si (KR)

(21) Appl. No.: 13/239,147

(22) Filed: Sep. 21, 2011

(30) Foreign Application Priority Data
Sep. 30, 2010 (KR) 10-2010-0095156

(51) Int. Cl. G06Q 30/00

(52) U.S. Cl. 705/14.42; 705/14.49

(57) ABSTRACT

Provided is a system and method for adjusting a number of advertisement inventories based on a competition factor. An advertisement inventory adjusting system includes a competition determining unit to determine a competition factor for a keyword, an advertisement inventory adjusting unit to dynamically adjust the number of advertisement inventories based on the determined competition factor, and a data storage medium to store advertisement inventories. A method that uses a processor to adjust a number of advertisement inventories includes determining a competition factor for a keyword advertisement with respect to a keyword, and dynamically adjusting, using the processor, the number of advertisement inventories based on the determined competition factor, in which the advertisement inventories refer to available areas to display the keyword advertisement.

### CROSS-REFERENCE TO RELATED APPLICATION

This application claims priority from and the benefit under 35 U.S.C. §119(a) of Korean Patent Application No. 10-2010-0095156, filed on Sep. 30, 2010, which is incorporated by reference for all purposes as if fully set forth herein.

### BACKGROUND

1. Field

The present disclosure relates to a system and method for adjusting a number of advertisement inventories or advertisement display areas based on a competition factor for a keyword advertisement.

2. Discussion of the Background

In Internet advertising, a keyword advertising using a competing bid scheme according to a keyword used in a search has been used as a conventional Internet advertising method. The keyword advertising may be provided during a keyword search using a search engine, which may be in a form of a search advertising that is provided as a response to the search query from a user. Further, even if the search query may not be received, the keyword advertising may be provided through one or more context clues that may be provided on of a web document or page.

In the case where keyword advertising employs the competing bid scheme, one or more advertisers may make a bid to display their corresponding advertisement according to a keyword used. Only advertisement of some advertisers among the advertisers participating in the bid may be displayed on a reference advertising display area.

The demand of advertisers may be different for each advertising keyword and thus, a competition relationship between advertisers for advertising display may be different for each keyword. However, in the conventional art, a predetermined number of advertising display areas is provided to advertisers without regard to their demands for particular keywords. Accordingly, the advertising profitability may be degraded.

### SUMMARY

Exemplary embodiments of the present invention provide a system and method for adjusting the number of advertisement inventories based on a competition factor.

Additional features of the invention will be set forth in the description which follows, and in part will be apparent from the description, or may be learned by practice of the invention.

Exemplary embodiments of the present invention provide a method that uses a processor to adjust a number of advertisement inventories including determining a competition factor for a keyword advertisement with respect to a keyword, and dynamically adjusting, using the processor, the number of advertisement inventories based on the determined competition factor, in which the advertisement inventories refer to available areas to display the keyword advertisement.

Exemplary embodiments of the present invention provide a method that uses a processor to adjust a number of advertisement inventories including determining a number of advertisement inventories with respect to a keyword, determining a number of valid advertisements with respect to the keyword, and determining, using the processor, whether a keyword advertisement competition has occurred based on the number of advertisement inventories and the number of valid advertisements.

Exemplary embodiments of the present invention provide a system to adjust a number of advertisement inventories including a competition determining unit to determine a competition factor for a keyword, an advertisement inventory adjusting unit to dynamically adjust the number of advertisement inventories based on the determined competition factor, and a data storage medium to store advertisement inventories, in which the advertisement inventories refer to available display areas to display a keyword advertisement associated with the keyword.

Exemplary embodiments of the present invention provide a system to adjust a number of advertisement inventories including a data storage medium to store advertisement inventories and valid advertisements, an advertisement inventory extracting unit to determine the number of advertisement inventories with respect to a keyword, a valid advertisement extracting unit to determine a number of valid advertisements with respect to the keyword, and a determining unit to determine whether a keyword advertisement competition has occurred based on the number of advertisement inventories and the number of valid advertisements.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a block diagram illustrating an operation of an advertisement inventory adjusting system according to an exemplary embodiment of the invention.

FIG. 2 is a flowchart illustrating a method for adjusting a number of advertisement inventories according to an exemplary embodiment of the invention.

FIG. 3 is a flowchart illustrating a method of adjusting a number of advertisement inventories according to an exemplary embodiment of the invention.

FIG. 4 is a graph illustrating a keyword advertisement competition according to an exemplary embodiment of the invention.

FIG. 5 is a graph illustrating a keyword advertisement competition according to an exemplary embodiment of the invention.

FIG. 6 is a graph illustrating adjustment of a number of advertisement inventories based on a competition factor according to an exemplary embodiment of the invention.

FIG. 7 is a graph illustrating a competition factor based on a number of valid advertisements and a number of registered advertisements according to an exemplary embodiment of the invention.

FIG. 8 is a block diagram illustrating an advertisement inventory adjusting system according to an exemplary embodiment of the invention.

FIG. 9 is a block diagram illustrating an advertisement inventory adjusting system according to an exemplary embodiment of the invention.

### DETAILED DESCRIPTION OF THE ILLUSTRATED EMBODIMENTS

Exemplary embodiments now will be described more fully hereinafter with reference to the accompanying drawings, in which exemplary embodiments are shown. The present disclosure may, however, be embodied in many different forms and should not be construed as limited to the exemplary embodiments set forth herein. Rather, these exemplary embodiments are provided so that the present disclosure is thorough and will fully convey the scope of the invention to those skilled in the art. Throughout the drawings and the detailed description, unless otherwise described, the same drawing reference numerals are understood to refer to the same elements, features, and structures. The relative size and depiction of these elements may be exaggerated for clarity, illustration, and convenience.

The terminology used herein is for the purpose of describing particular embodiments only and is not intended to be limiting of the present disclosure. Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Hereinafter, exemplary embodiments of the present invention will be described with reference to the accompanying drawings. A method of adjusting an advertisement inventory according to an exemplary embodiment of the present invention may be performed by an advertisement inventory adjusting system according to an exemplary embodiment of the present invention or other suitable systems.

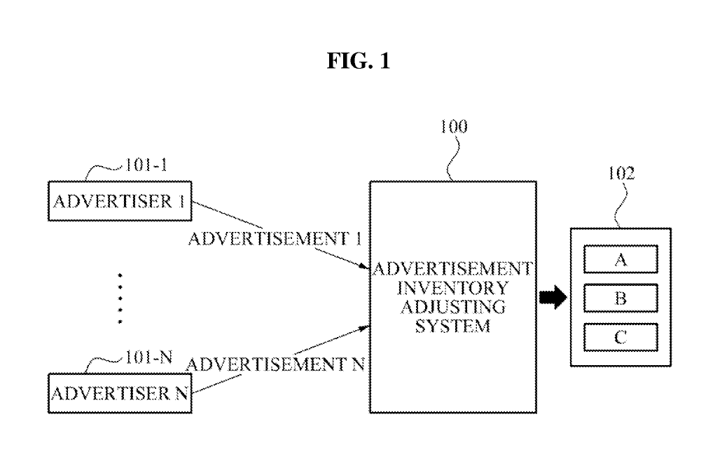

FIG. 1 is a block diagram illustrating an operation of an advertisement inventory adjusting system according to an exemplary embodiment of the invention.

Advertisers 101-1˜101-N may make a bid on a keyword search and thereby register a keyword advertisement associated with one or more keywords in an advertisement inventory adjusting system 100. The keyword advertisement may be displayed as a part of a search result if a user inputs a corresponding search keyword in a search engine. Further, the keyword advertisement may be combined with a text to be displayed if the keyword advertisement is associated with a keyword included in the text.

According to aspects of the invention, a number of keyword advertisements that may be registered for one or more reference keywords may be more than a number of areas that may be available to display the keyword advertisements. The keyword advertisement may be registered through a bidding process or other suitable methods. A display area of a keyword advertisement may be referred to as an advertisement inventory. As shown in FIG. 1, a database or a server 102 may store one or more advertisement inventories, such as advertisement inventories A, B, and C.

However, it may become an issue if the number of advertisement inventories is fixed or limited and the number of keyword advertisements registered grows to be larger than the number of advertisement inventories, which may be fixed or limited. If the number of registered keyword advertisements grows to be greater than the number of advertisement inventories, not all of the registered keyword advertisements may be displayed, since the number of keyword advertisements that may be displayed is limited by the number of advertisement inventories that may be available. Accordingly, keyword advertisements of all advertisers cannot be displayed and thus, a competition may occur between the advertisers for the limited advertisement inventories.

Further, if the number of registered keyword advertisements is less than the number of advertisement inventories that may be available, some of the registered keyword advertisement may be displayed. Accordingly, an entity that operates and sells keyword advertisement inventories may have unused advertisement inventories and thus, the advertisement profitability may be degraded.

The advertisement inventory adjusting system 100 may adjust the number or size of display areas or advertisement inventories that may be available by determining an advertising competition based on the number of keyword advertisements registered and the available number of advertisement inventories. According to aspects of the invention, there is no constraint on a form of the advertisement inventory.

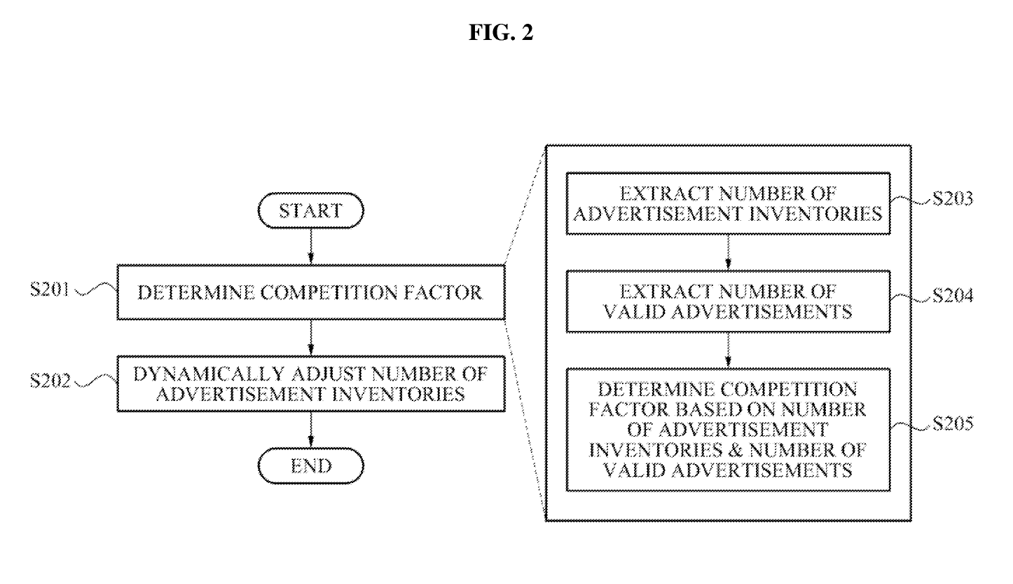

FIG. 2 is a flowchart illustrating a method for adjusting a number of advertisement inventories according to an exemplary embodiment of the invention.

In operation S201, the advertisement inventory adjusting system 100 may determine a competition factor for a keyword advertisement for a keyword. As shown in FIG. 2, operation S201 may additionally include operations S203, S204, and S205.

In operation S203, the advertisement inventory adjusting system 100 may determine and/or extract the number of advertisement inventories or display areas of keyword advertisements that may be available for the keyword. Further, the advertisement inventories may indicate a particular advertisement area to display the keyword advertisement. According to aspects of the invention, the advertisement areas may be designated according to relevancy of the corresponding keyword advertisement with respect to a keyword inputted by a user. The more relevant keyword advertisement may be designated to a prime advertisement area, whereas less relevant keyword advertisement may be given secondary advertisement areas. Further, the corresponding keyword advertisements may be ranked based on their relevancy. Also, if a charging scheme is applied to the keyword advertisements, the charges may be adjusted based on a ranking index of the keyword advertisements. According to aspects of the invention, charges may be applied to keyword advertisements corresponding to a reference ranking in the advertisement inventory and other keyword advertisements that are ranked higher or lower than the reference ranking. For example, charges may be applied to the second lowest ranking keyword advertisement in the advertisement inventory and the other keyword advertisements with higher rankings.

In operation S204, the advertisement inventory adjusting system 100 may determine and/or extract the number of valid advertisements exceeding an advertisement performance threshold. According to aspects of the invention, the advertisement performance threshold may be predetermined or determined in real-time based on the keyword. The reference advertisement performance may refer to an indication that a reference amount of valid sales have occurred. The valid sales may be determined based on revenues that an advertiser has made. For example, the valid sales may be determined based on a behavior of a user who purchases a product at a site of the advertiser using a conversion rate, and the like. The valid advertisement may refer to advertisement of advertisers that may have intent to compete for the keyword advertisement display areas or advertisement inventory.

In operation S205, the advertisement inventory adjusting system 100 may determine the competition factor for the keyword advertisement display area or advertisement inventory based on the number of available advertisement inventories and the number of valid advertisements. According to aspects of the invention, if the number of available advertisement inventories is less than the number of valid advertisements, the advertisement inventory adjusting system 100 may determine that the keyword advertisement competition has occurred. As the above difference between the number of available advertisement inventories and the number of valid advertisements increases, such that the number of valid advertisements outgrows the number of available advertisement inventories, the competition factor for the keyword advertisement may increase.

Further, if the number of available advertisement inventories is greater than or equal to the number of valid advertisements, the advertisement inventory adjusting system 100 may determine that the keyword advertisement competition has not occurred. The competition factor may be calculated based on the difference between the number of valid advertisements and the number of available advertisement inventories (i.e., [number of valid advertisement]=[number of available advertisement inventories]=[difference]). If a “−” value or 0 is induced, it indicates that the competition has not occurred. If “+” value is induced, it indicates that the competition has occurred.

In operation S202, the advertisement inventory adjusting system 100 may dynamically adjust the number of advertisement inventories, in which keyword advertisements associated with the keyword are to be displayed based on a competition factor. The advertisement inventory adjusting system 100 may increase the number of advertisement inventories as the competition factor for the keyword advertisement competition increases. For example, if the keyword advertisement competition occurs, the advertisement inventory adjusting system 100 may increase the number of advertisement inventories that may be available to be equal to the number of valid advertisements. Further, the advertisement inventory adjusting system 100 may also decrease the number of advertisement inventories that be available to be equal to the number of valid advertisements, if the number of valid advertisements is greater than the number of available advertisement inventories.

A determination of whether to adjust the number of advertisement inventories may vary based on a system circumstance. The advertisement inventory adjusting system 100 may receive a feedback regarding a case where the competition does not exist due to a large number of available advertisement inventories. For example, in a case where Pay Per Click (PPC) significantly decreases, the advertisement inventory adjusting system 100 may adjust the number of advertisement inventories by reducing the number of available advertisement inventories.

According aspects of the invention, a high competition factor for the keyword advertisement may indicate that many advertisers may have intent to compete for the limited number of advertisement inventories. Therefore, the advertisement inventory adjusting system 100 may assign an advertisement display opportunity to advertisers who may have the intent to compete, by increasing the number of advertisement inventories. Accordingly, the advertising profitability according to an advertisement display may be enhanced for the advertiser of the respective advertisement.

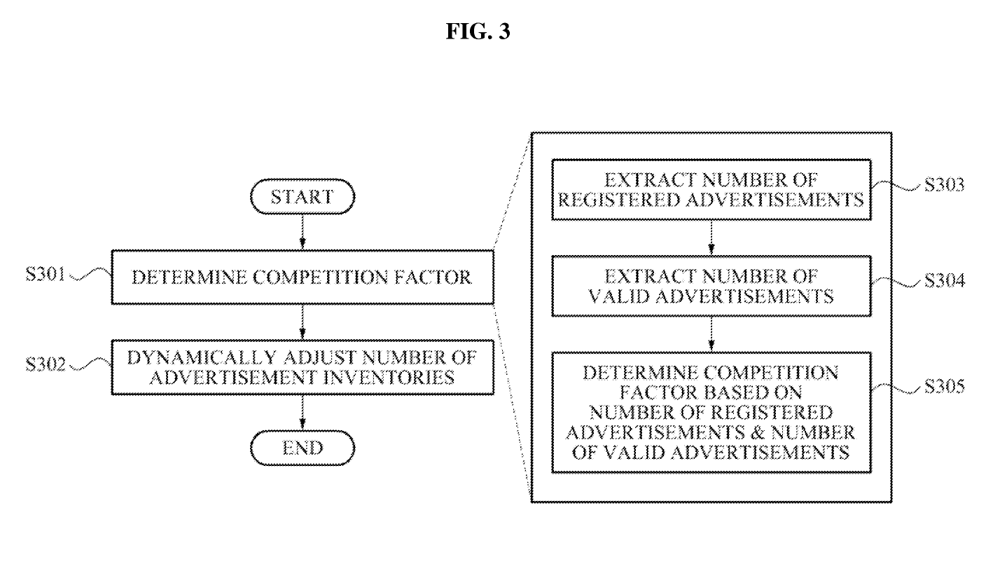

FIG. 3 is a flowchart illustrating a method of adjusting a number of advertisement inventories according to an exemplary embodiment of the invention.

In operation S301, the advertisement inventory adjusting system 100 may determine a competition factor for a keyword advertisement for a keyword. As shown in FIG. 3, operation S301 may additionally include operations S303, S304, and S305.

In operation S303, the advertisement inventory adjusting system 100 may determine and/or extract the number of registered advertisements that are registered with respect to one or more keywords. The registered advertisement may correspond to a keyword advertisement that may be registered through a bid process for a reference keyword. Thus, the registered advertisement may indicate an advertisement having a probability to be displayed in an advertisement inventory based on a subsequent bid circumstance.

In operation S304, the advertisement inventory adjusting system 100 may determine and/or extract the number of valid advertisements exhibiting an advertisement performance that exceed a reference threshold with respect to the keyword. According to aspects of the invention, the reference advertisement performance may refer to an indication that a reference amount of valid sales have occurred. The valid sales may be determined based on revenues that an advertiser has made.

In operation S305, the advertisement inventory adjusting system 100 may determine the competition factor for the keyword advertisement competition based on the number of registered advertisements and the number of valid advertisements.

If the number of registered keyword advertisements is less than the number of valid advertisements, the advertisement inventory adjusting system 100 may determine that the keyword advertisement competition has occurred. As the above difference between the number of registered advertisements and the number of valid advertisements increases (i.e., [number of valid advertisements]−[number of registered advertisements]=[difference]), the competition factor for the keyword advertisements may increase.

If the number of registered advertisements is greater than or equal to the number of valid advertisements, the advertisement inventory adjusting system 100 may determine that the keyword advertisement competition has not yet occurred. The competition factor may be calculated based on the difference between the number of valid advertisements and the number of registered advertisements (i.e., [number of valid advertisement]−[number of advertisement inventories]=[difference]). If “−” value or 0 is induced, it may indicate that the competition has not occurred. If “+” value is induced, it may indicate that the competition has occurred.

In operation S302, the advertisement inventory adjusting system 100 may dynamically adjust the number of registered keyword advertisements to be displayed based on a competition factor. The advertisement inventory adjusting system 100 may increase the number of registered advertisements as the competition factor for the keyword advertisement increases. For example, if the keyword advertisement competition occurs, the advertisement inventory adjusting system 100 may increase the number of registered advertisements to be at least equal to the number of valid advertisements.

According to aspects of the invention, a high competition factor for the keyword advertisement competition may indicate that many advertisers may have intent to compete for the limited number of advertisement inventories.

Although not illustrated in FIG. 2 or FIG. 3, the advertisement inventory adjusting system 100 may report whether a keyword advertisement competing circumstance has occurred, based on the number of advertisement inventories and the number of valid advertisements. For example, if the number of advertisement inventories is less than the number of valid advertisements, the advertisements inventory adjusting system 100 may report that the keyword advertisements competing circumstance has occurred.

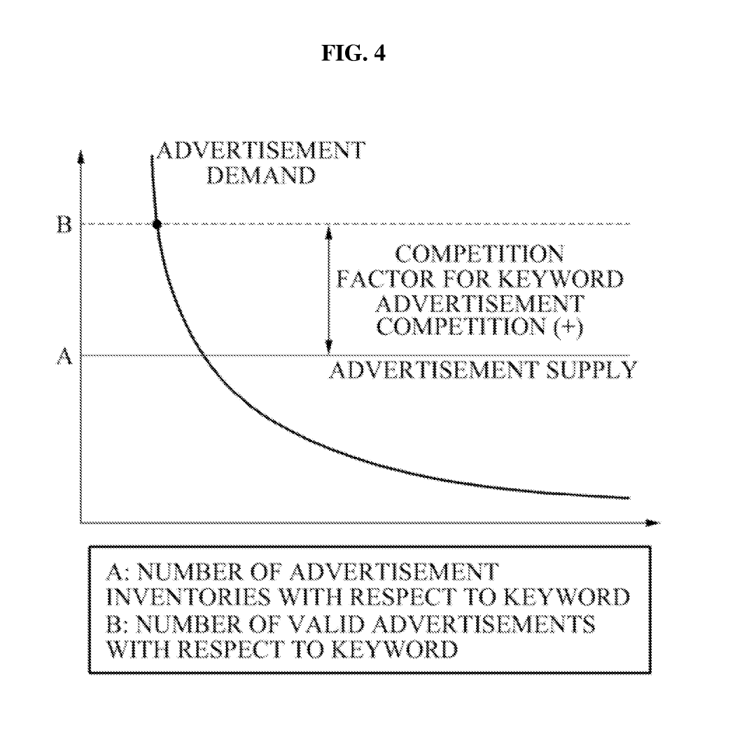

FIG. 4 is a graph illustrating a keyword advertisement competition according to an exemplary embodiment of the invention.

FIG. 4 illustrates relationship between the number of valid advertisements indicating an advertisement demand and the number of advertisement inventories indicating a supply of display area for the respective advertisements. Referring to FIG. 4, if A refers to the number of advertisement inventories corresponding to a keyword and B refers to the number of valid advertisements, a difference between B and A resulting a “+” value or positive numerical value may indicate that keyword advertisement competition has occurred. That is, the keyword advertisement competition may occur if the advertisement demand is greater than the advertisement supply.

If the keyword advertisement competition occurs, the advertisement inventory adjusting system 100 may balance the advertisement supply with the advertisement demand by increasing the advertisement supply to be at least equal to the advertisement demand.

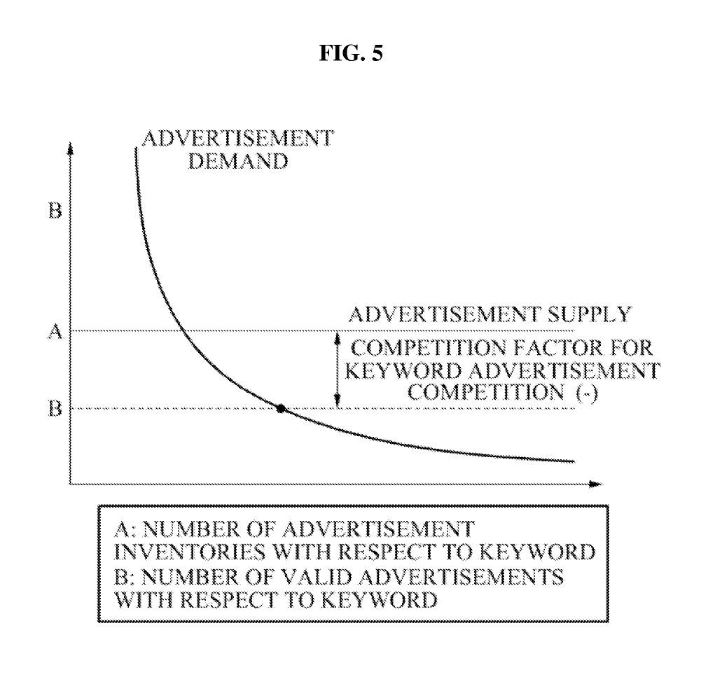

FIG. 5 is a graph illustrating a keyword advertisement competition according to an exemplary embodiment of the invention.

FIG. 5 illustrates relationship between the number of valid advertisements indicating an advertisement demand and the number of advertisement inventories indicating a supply of display area for the respective advertisement. Referring to FIG. 5, if A refers to the number of advertisement inventories corresponding to a keyword and B refers to the number of valid advertisements, a difference between B and A resulting a “−” value, a negative numerical value, or a zero value may indicate that keyword advertisement competition has not occurred. That is, the keyword advertisement competition may occur if the advertisement supply is greater than the advertisement demand. That is, the keyword advertisement competition may occur if the advertisement demand is greater than the advertisement supply.

If the keyword advertisement competition does not occur, the advertisement inventory adjusting system 100 may balance the advertisement supply with the advertisement demand by decreasing the advertisement supply to be at least equal to the advertisement demand.

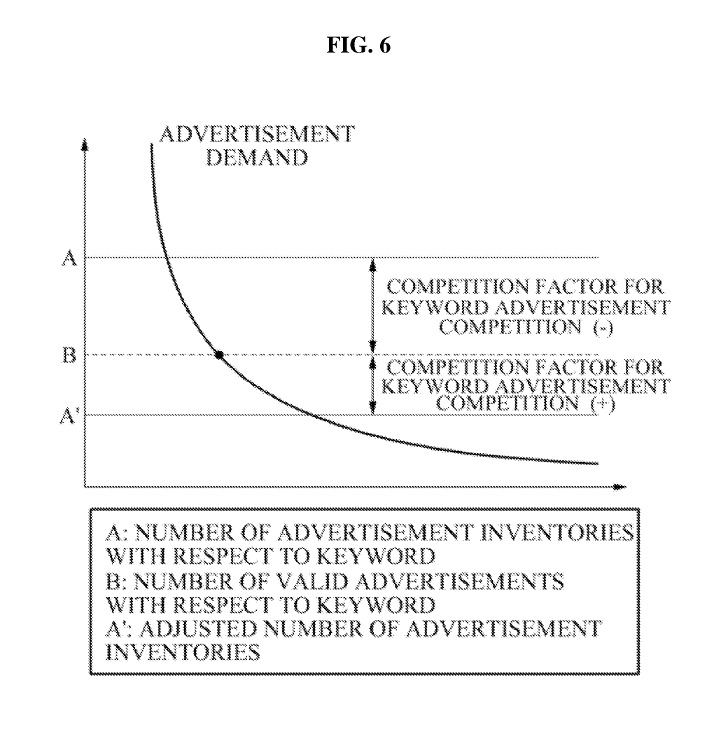

FIG. 6 is a graph illustrating adjustment of a number of advertisement inventories based on a competition factor according to an exemplary embodiment of the invention.

Referring FIG. 6, if A refers to the number of advertisement inventories corresponding to a keyword and B refers to the number of valid advertisements, a difference between B and A resulting a “+” value or a positive numerical value may indicate that keyword advertisement competition may not occur. Accordingly, the advertisement inventory adjusting system 100 may adjust the number of advertisement inventories from A to A′. According to aspects of the invention, if the advertisement inventory adjusting system 100 may decrease the advertisement supply by reducing the number of advertisement inventories from A to A′, the difference between B and A may result a “−” value, a negative numerical value, or a zero value to indicate a keyword advertisement competition. Accordingly, the advertisement inventory adjusting system 100 may decrease the number of advertisement inventories to be from A to less than or equal to B to provide keyword advertisement competition amongst the advertisers.

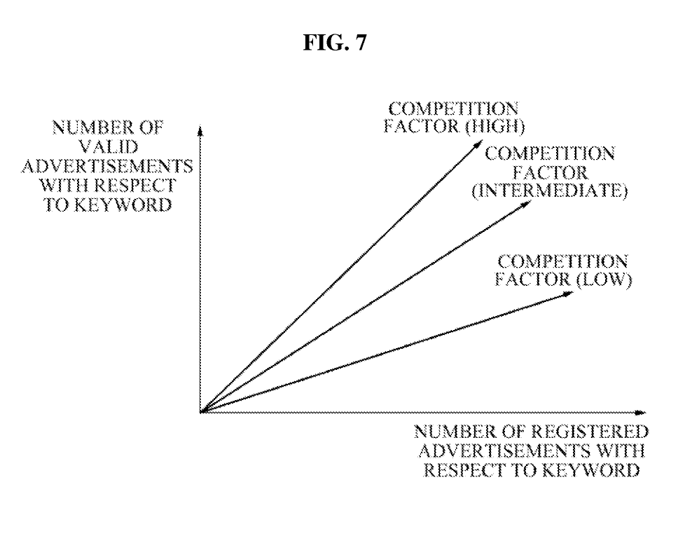

FIG. 7 is a graph illustrating a competition factor based on a number of valid advertisements and a number of registered advertisements according to an exemplary embodiment of the invention.

FIG. 7 illustrates a relationship between a number of valid keyword advertisements and a number of registered keyword advertisements. If the number of valid advertisements is greater than the number of registered advertisements, a steep slope may be illustrated on the graph to indicate a high competition factor. Also, if the number of valid advertisements is similar to the number of registered advertisements an intermediate slope may be illustrated on the graph to indicate that an intermediate competition factor. Also, if the number of valid advertisements is less than the number of registered advertisements, a slight slope may be illustrated on the graph to indicate a low competition factor.

The advertisement inventory adjusting system 100 may adjust the number of advertisement inventories based on the competition factor. That is, if the keyword advertisement competition occurs and/or the competition factor is determined to be high, the advertisement inventory adjusting system 100 may not adjust the number of advertisement inventories. If the keyword advertisement competition does not occur and/or the competition factor is determined to be low, the advertisement inventory adjusting system 100 may cause or initiate the keyword advertisement competition by decreasing the number of advertisement inventories.

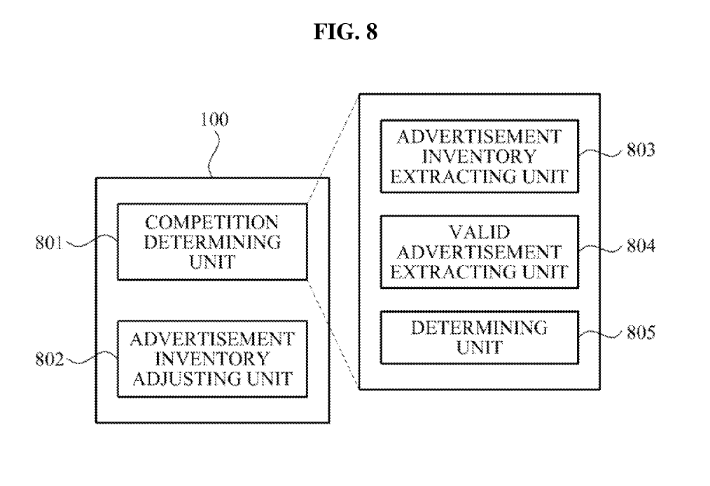

FIG. 8 is a block diagram illustrating an advertisement inventory adjusting system according to an exemplary embodiment of the invention.

As shown in FIG. 8, the advertisement inventory adjusting system 100 includes a competition determining unit 801 and an advertisement inventory adjusting unit 802. The competition determining unit 801 further includes an advertisement inventory extracting unit 803, a valid advertisement extracting unit 804, and a determining unit 805.

The competition determining unit 801 may determine a competition factor for a keyword advertisement competition with respect to a keyword. The keyword advertisement may be applied to a charging scheme of adjusting a charge based on a ranking index of an advertisement listing. According to aspect of the invention, a charge may be applied to a ranking index corresponding to a reference lowest ranking advertisement inventory and up.

The advertisement inventory extracting unit 803 may determine and/or extract the number of advertisement inventories, which may be display areas of keyword advertisements, associated with the keyword advertisement competition.

The valid advertisement extracting unit 804 may determine and/or extract the number of valid advertisements exceeding a reference advertising performance according to the keyword.

The determining unit 805 may determine the competition factor for the keyword advertisement competition based on the number of advertisement inventories and the number of valid advertisements. In this example, if the number of advertisement inventories is less than the number of valid advertisements, the determining unit 805 may determine that the keyword advertisement competition has occurred.

The advertisement inventory adjusting unit 802 may dynamically adjust the number of advertisement inventories, in which the keyword advertisements associated with the keyword advertisement competition are to be displayed, based on the determined competition factor. For example, the advertisement inventory adjusting unit 802 may increase the number of advertisement inventories as the competition factor for the keyword advertisement competition increases.

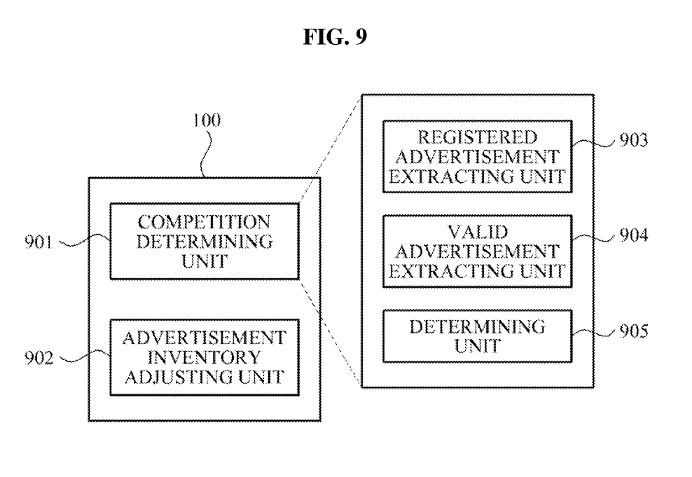

FIG. 9 is a block diagram illustrating an advertisement inventory adjusting system according to an exemplary embodiment of the invention.

As shown in FIG. 9, the advertisement inventory adjusting system 100 includes a competition determining unit 901 and an advertisement inventory adjusting unit 902. The competition determining unit 901 further includes a registered advertisement extracting unit 903, a valid advertisement extracting unit 904, and a determining unit 905.

The competition determining unit 901 may determine a competition factor of a keyword advertisement competition with respect to a keyword. The keyword advertisement may be applied to a charging scheme of adjusting a charge based on a ranking index of an advertisement listing corresponding to a reference lowest ranking advertisement inventory and up.

The registered advertisement extracting unit 903 may determine and/or extract the number of registered advertisements that are registered with respect to the keyword.

The valid advertisement extracting unit 904 may determine and/or extract the number of valid advertisements exhibiting an advertising performance that exceeds a reference threshold according to the keyword.

The determining unit 905 may determine the competition factor for the keyword advertisement competition based on the number of registered advertisements and the number of valid advertisements. According to aspects of the invention, if the number of registered advertisements is less than the number of valid advertisements, the determining unit 805 may determine that the keyword advertisement competition has occurred.

The advertisement inventory adjusting unit 902 may dynamically adjust the number of advertisement inventories to display the keyword advertisements based on the determined competition factor. For example, the advertisement inventory adjusting unit 802 may increase the number of advertisement inventories as the competition factor for the keyword advertisement competition increases.

According to exemplary embodiments of the present invention, it may be possible to reflect a competition factor related to a keyword advertisement and to enhance the advertising profitability by adjusting the number of advertisement inventories.

Also, according to exemplary embodiments of the present invention, it may be possible to enhance the advertisement profitability by decreasing the number of advertisement inventories if a no competition relationship is present for a keyword advertisement amongst the advertisers.

Also, according to exemplary embodiments of the present invention, it is possible to increase the number of advertisement inventories if a competition relationship among the advertisers with respect to a keyword advertisement exists, and thereby assign an advertisement display opportunity to an advertiser who desires to display an advertisement.

The exemplary embodiments according to the present invention may be recorded in computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of computer-readable media include magnetic media such as hard disks, floppy disks, and magnetic tape; optical media such as CD ROM disks and DVD; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A method that uses a processor to adjust a number of advertisement inventories, the method comprising:
determining a competition factor for a keyword advertisement with respect to a keyword; and
dynamically adjusting, using the processor, the number of advertisement inventories based on the determined competition factor, wherein the advertisement inventories refer to available areas to display the keyword advertisement.

2. The method of claim 1, wherein the determining a competition factor for a keyword advertisement comprises:
determining the number of advertisement inventories with respect to the keyword;
determining a number of valid advertisements with an advertising performance exceeding a reference threshold with respect to the keyword; and
determining the competition factor for the keyword advertisement based on the number of advertisement inventories and a number of valid advertisements.

3. The method of claim 2, wherein the advertising performance is measured in amount of valid sales through the keyword advertisement, and valid advertisements refers to a keyword advertisement of an advertiser for the advertisement inventory.

4. The method of claim 1, wherein the determining a competition factor for a keyword advertisement comprises:
determining a number of registered advertisements that are registered with respect to the keyword;
determining a number of valid advertisements exhibiting an advertising performance that exceeds a reference threshold with respect to the keyword; and
determining the competition factor for the keyword advertisement based on the number of registered advertisements and the number of valid advertisements.

5. The method of claim 1, wherein dynamically adjusting the number of advertisement inventories comprises increasing the number of advertisement inventories as the competition factor for the keyword advertisement increases.

6. The method of claim 1, wherein the keyword advertisement further comprising charging for the keyword advertisement, wherein a charge is adjusted based on a ranking of the keyword advertisement.

7. A method that uses a processor to adjust a number of advertisement inventories, the method comprising:
determining a number of advertisement inventories with respect to a keyword;
determining a number of valid advertisements with respect to the keyword; and
determining, using the processor, whether a keyword advertisement competition has occurred based on the number of advertisement inventories and the number of valid advertisements.

8. The method of claim 7, wherein the valid advertisements refers to a keyword advertisement of an advertiser for the advertisement inventory.

9. The method of claim 7, wherein the keyword advertisement competition is determined to have occurred in response to the number of advertisement inventories being determined to be less than the number of valid advertisements.

10. A system to adjust a number of advertisement inventories, the system comprising:
a competition determining unit to determine a competition factor for a keyword;
an advertisement inventory adjusting unit to dynamically adjust the number of advertisement inventories based on the determined competition factor; and
a data storage medium to store advertisement inventories, wherein the advertisement inventories refer to available areas to display a keyword advertisement associated with the keyword.

11. The system of claim 10, wherein the competition determining unit comprises:
an advertisement inventory extracting unit to determine the number of advertisement inventories with respect to the keyword;
a valid advertisement extracting unit to determine a number of valid advertisements with an advertising performance exceeding a reference threshold with respect to the keyword; and
a determining unit to determine the competition factor for the keyword advertisement based on the number of advertisement inventories and the number of valid advertisements.

12. The system of claim 11, wherein the advertising performance is measured in amount of valid sales through the keyword advertisement, and valid advertisements refers to a keyword advertisement of an advertiser for the advertisement inventory.

13. The system of claim 10, wherein the competition determining unit comprises:
a registered advertisement extracting unit to determine a number of registered advertisements that are registered with respect to the keyword;
a valid advertisement extracting unit to determine a number of valid advertisements exhibiting an advertising performance that exceeds a reference threshold with respect to the keyword; and
a determining unit to determine the competition factor for the keyword advertisement based on the number of registered advertisements and the number of valid advertisements.

14. The system of claim 10, wherein the advertisement inventory adjusting unit increases the number of advertisement inventories as the competition factor for the keyword advertisement increases.

15. The system of claim 10, wherein the keyword advertisement further comprising charging for the keyword advertisement, wherein a charge is adjusted based on a ranking of the keyword advertisement.

16. A system to adjust a number of advertisement inventories, the system comprising:
a data storage medium to store advertisement inventories and valid advertisements;
an advertisement inventory extracting unit to determine the number of advertisement inventories with respect to a keyword;
a valid advertisement extracting unit to determine a number of valid advertisements with respect to the keyword; and
a determining unit to determine whether a keyword advertisement competition has occurred based on the number of advertisement inventories and the number of valid advertisements.

17. The system of claim 16, wherein the determining unit determines that the keyword advertisement competition has occurred in response to the number of advertisement inventories being determined to be less than the number of valid advertisements.

18. A non-transitory computer-readable medium comprising a program for instructing a computer to perform the method of claim 1.

19. A non-transitory computer-readable medium comprising a program for instructing a computer to perform the method of claim 7.
